(19) United States
(12) Patent Application Publication
(10) Pub. No.: US 2010/0258548 A1
(43) Pub. Date: Oct. 14, 2010

(54) Heatable handle device for vehicle

(76) Inventor: Shih Hsiung Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,558

(22) Filed: Apr. 13, 2009

(51) Int. Cl. B60L 1/02

(52) U.S. Cl. 219/204

(57) ABSTRACT

A handle device includes an inner handle having an outer periphery with two parallel, helical grooves each having first and second end sections at two ends of the outer periphery. The second end sections of the helical grooves meet with each other at a recessed connecting section including a projecting portion on an end of the outer periphery and having a receiving compartment in communication with the second end sections of the helical grooves. A heating wire extends through two through-holes in a wire seat formed on the other end of the outer periphery. The heating wire includes two wire sections respectively received in the helical grooves. The wire sections are interconnected to each other at a bend that is received in the receiving compartment. An outer handle is integrally formed around the outer periphery of the inner handle as a single monolithic piece.

### BACKGROUND OF THE INVENTION

The present invention relates to a handle device for a vehicle and, more particularly, to a heatable handle device for a vehicle including a heating wire.

The hands of drivers of vehicles such as motorcycles, snowmobiles, skibobs, or the like are less nimble in cold zones. The handles of such vehicles are liable to deteriorate due to low temperatures, adversely affecting the function of the handles. To avoid these problems, a heating wire is wound around an inner handle, and the inner handle is forcibly inserted into an outer handle. However, the heating wire must be fixed in place by tapes or the like. In another approach, the inner handle includes a helical groove, and the heating wire is placed in the helical groove before inserting the inner handle into the outer handle. However, the outer handle tends to slide relative to the inner handle due to heat expansion and cold shrinkage, adversely affecting the function of the whole handle.

Integral formation of the inner and outer handles by injection molding is a solution to the sliding problem. However, loosening and entanglement of the heating wire is another issue during injection molding. U.S. Pat. No. 6,686,572 discloses an inner handle including a tubular member having two parallel, helical recessed portions formed on an outer periphery thereof. A rubber jacket is mounted around the tubular member. Two heating coils of different heating efficiency are respectively mounted in the parallel, helical recessed portions for heating the rubber jacket. The parallel, helical recessed portions are formed by four rows of protrusions formed on the outer periphery of the tubular member and extend along a direction parallel to a longitudinal axis of the tubular member. Short circuit and malfunctioning of the heating coils are avoided in addition to retaining the heating coils in the recessed portions. However, even though the tubular member is covered by the rubber jacket, the protrusions still cause uncomfortable feeling to the hand of the user. Furthermore, the retaining effect of the heating coils are not reliable enough, leading to the risk of undesired movement of the heating coils during the subsequent injection molding for bonding the inner handle and an outer handle.

FIG. 5 shows a conventional heatable inner handle 4 including a helical groove in an outer periphery thereof. A plurality of protrusions 41 are formed on a bottom wall of the helical groove. A heating strip 51 is received in the helical groove and includes a plurality of through-holes 511 engaged with the protrusions 41 for positioning the heating strip 51. However, alignment the through-holes 511 with the protrusions 41 is a problem, for the heating strip 51 must be electrically connected to a heating wire before mounting the heating strip 51 in the helical groove.

Thus, a need exists for a heatable handle device for a vehicle that can be easily manufactured by injection molding while reliably positioning the heating wire.

### BRIEF SUMMARY OF THE INVENTION

The present invention solves this need and other problems in the field of reliable positioning by providing, in a preferred form, a handle device including an inner handle having an outer periphery with first and second ends spaced along a longitudinal axis of the inner handle. A wire seat is formed on the first end of the outer periphery and includes first and second through-holes. The outer periphery includes parallel, first and second helical grooves. Each of the first and second helical grooves includes a first end section in the first end of the outer periphery. Each of the first and second helical grooves further includes a second end section in the second end of the outer periphery. The second end sections of the first and second helical grooves meet with each other at a recessed connecting section at the second end of the outer periphery. The recessed connecting section includes a projecting portion extending radially away from the outer periphery of the inner handle. The projecting portion has a receiving compartment along a perimeter thereof. Each of the second end sections of the first and second helical -grooves is in communication with the receiving compartment. A heating wire extends through the first and second through-holes of the wire seat. The heating wire includes a first wire section received in the first helical groove. The heating wire further includes a second wire section received in the second helical groove. The first and second wire sections are interconnected to each other at a bend that is received in the receiving compartment. An outer handle is mounted around the outer periphery of the inner handle. The inner and outer handles are integrally formed as a single monolithic piece.

Preferably, the inner handle further includes a ridge formed on the first end of the outer periphery. The first end section of the first helical groove is spaced from the first end section of the second helical groove along the longitudinal axis by the ridge.

Preferably, the inner and outer handles have a melting point difference smaller than 30° C. Most preferably, the inner and outer handles are made of the same material.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a diagrammatic perspective view of an inner handle of a handle device according to the preferred teachings of the present invention with a heating wire fixed to the inner handle.

FIG. 1A shows a cross sectional view of a circled portion in FIG. 1.

FIG. 2 shows a partial, perspective view of the inner handle of the handle device of FIG. 1.

FIG. 3 shows an exploded, perspective view of the heating wire and the inner handle of FIG. 1.

FIG. 4 shows a perspective view of the handle device of FIG. 1.

FIG. 5 shows a perspective view of a conventional heatable inner handle.

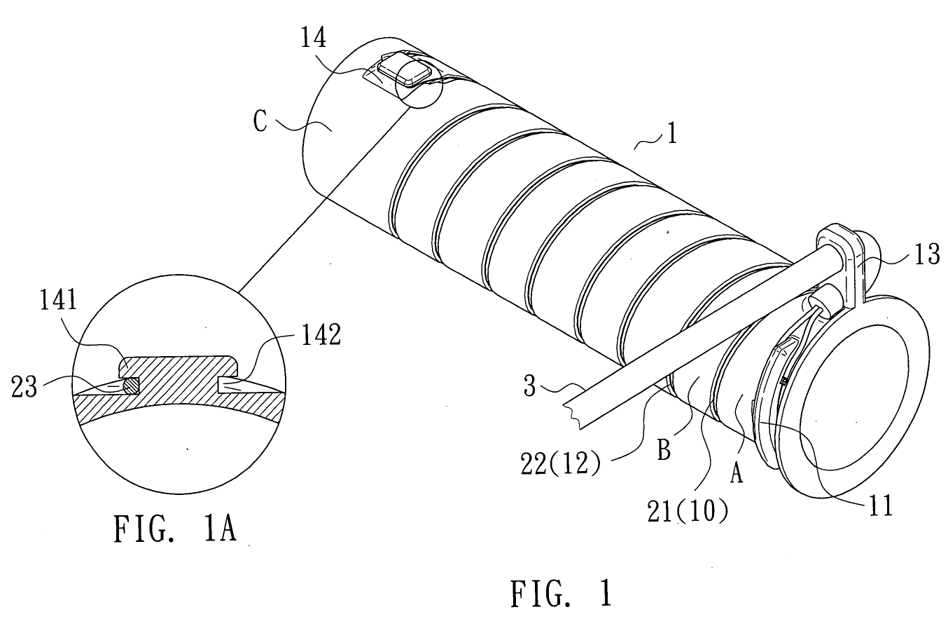

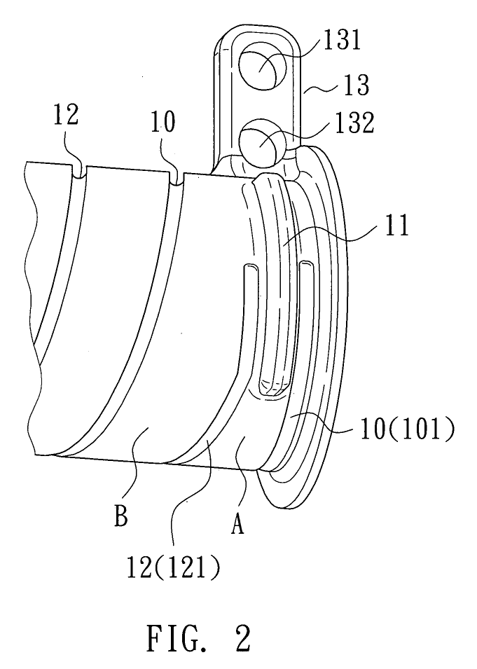

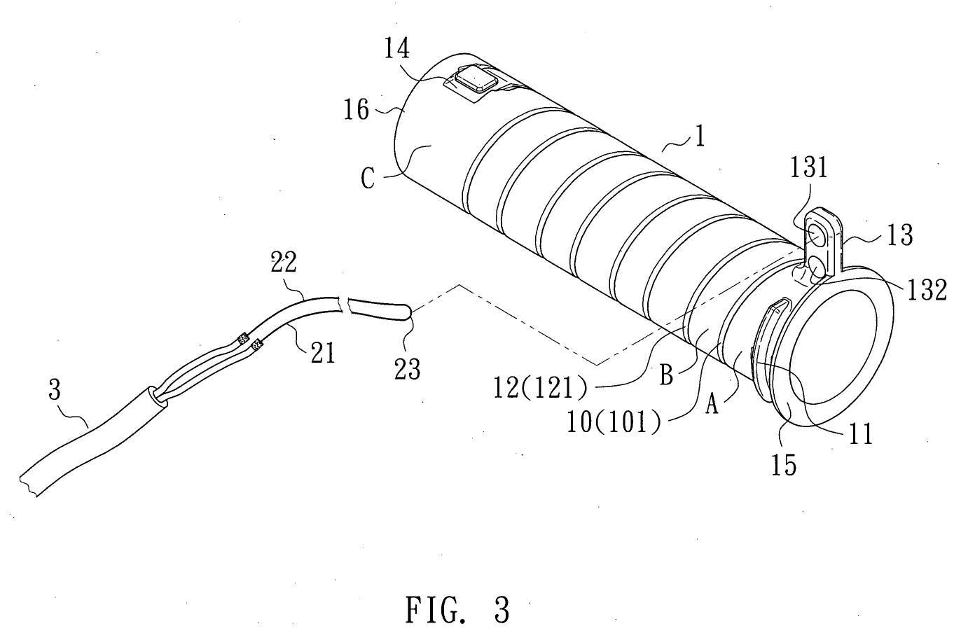

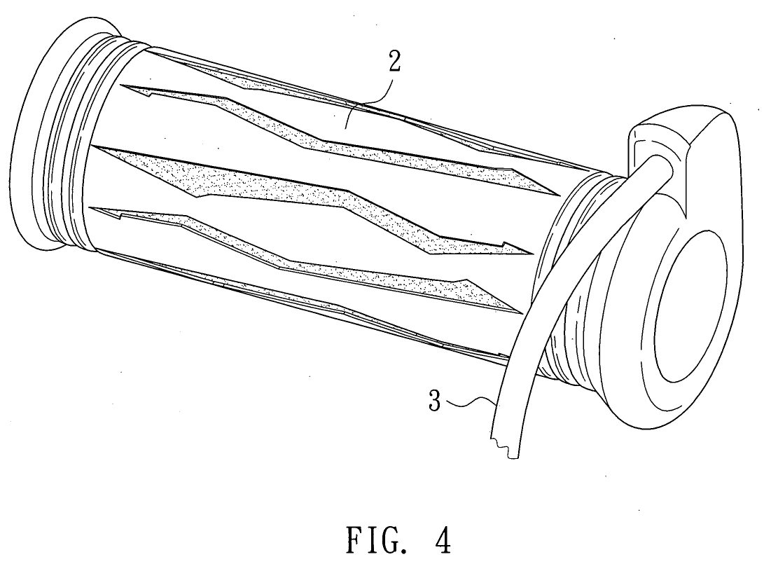

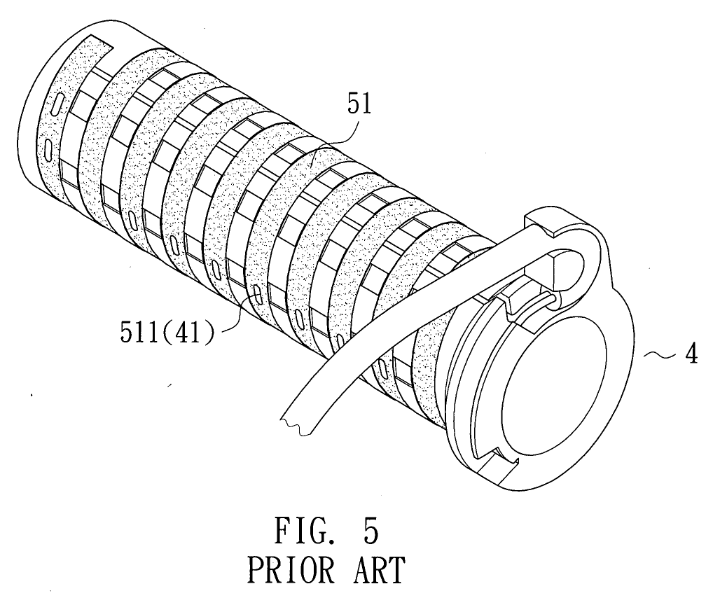

### DETAILED DESCRIPTION OF THE INVENTION

A heatable handle device according to the preferred teachings of the present invention is shown in the drawings and generally includes an inner handle 1 having an outer periphery with first and second ends 15 and 16 spaced along a longitudinal axis of the inner handle 1. A wire seat 13 is formed on the first end 15 of the outer periphery and includes first and second through-holes 131 and 132. The outer periphery includes parallel, first and second helical grooves 10 and 12. Each of the first and second helical grooves 10 and 12 includes a first end section 101, 121 in the first end 15 of the outer periphery. Each of the first and second helical grooves 10 and 12 further includes a second end section in the second end 16 of the outer periphery. The second end sections of the first and second helical grooves 10 and 12 meet with each other at a recessed connecting section 14 at the second end 16 of the outer periphery. The recessed connecting section 14 includes a projecting portion 141 extending radially away from the outer periphery of the inner handle 1. The projecting portion 141 includes a receiving compartment 142 along a perimeter thereof. The receiving compartment 142 is in communication with the second end sections of the first and second helical grooves 10 and 12. The inner handle 1 further includes a ridge 11 formed on the first end 15 of the outer periphery. The first end section 101 of the first helical groove 10 is spaced from the first end section 121 of the second helical groove 12 along the longitudinal axis by the ridge 11.

A heating wire 3 extends through the first and second through-holes 131 and 132 of the wire seat 13. The heating wire 3 includes a first wire section 21 received in the first helical groove 10. The heating wire 3 further includes a second wire section 22 received in the second helical groove 12. The first and second wire sections 21 and 22 are interconnected to each other at a bend 23 that is received in the receiving compartment 142. The heating wire 3, when supplied with current, generates heat to warm the hand of the user. Due to provision of the ridge 15 separating the first end section 101 of the first helical groove 10 from the first end section 121 of the second helical groove 12, the entanglement of the first and second wire sections 21 and 22 and the resultant short circuit are avoided. The bend 23 is securely received in the receiving compartment 142 that provides a hooking effect to retain the bend 23 in place, assuring reliable positioning of the heating wire 13.

An outer handle 2 is mounted around the outer periphery of the inner handle 1. Preferably, the inner and outer handle 1 and 2 are integrally formed as a single monolithic piece by injection molding. Preferably, the inner and outer handles have a melting point difference smaller than 30° C. Most preferably, the inner and outer handles 1 and 2 are made of the same material. Preferably, the inner handle 1 is made of an elastomeric material to provide a comfortable touch.

The outer periphery of the inner handle 1 is free of protrusions. Specifically, sections A, B, and C of the outer, periphery of the inner handle 1 have the same spacing to the longitudinal axis of the inner handle 1. Thus, the user will not feel uncomfortable after the outer handle 2 is formed around the inner handle 1.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A handle device comprising:
an inner handle including an outer periphery having first and second ends spaced along a longitudinal axis of the inner handle, with a wire seat being formed on the first end of the outer periphery and including first and second through-holes, with the outer periphery including parallel, first and second helical grooves, with each of the first and second helical grooves including a first end section in the first end of the outer periphery, with each of the first and second helical grooves further including a second end section in the second end of the outer periphery, with the second end sections of the first and second helical grooves meeting with each other at a recessed connecting section at the second end of the outer periphery, with the recessed connecting section including a projecting portion extending radially away from the outer periphery of the inner handle, with the projecting portion having a receiving compartment along a perimeter thereof, with each of the second end sections of the first and second helical grooves being in communication with the receiving compartment;
a heating wire extending through the first and second through-holes of the wire seat, with the heating wire including a first wire section received in the first helical groove, with the heating wire further including a second wire section received in the second helical groove, with the first and second wire sections interconnected to each other at a bend, with the bend received in the receiving compartment; and
an outer handle mounted around the outer periphery of the inner handle, with the inner and outer handle being integrally formed as a single monolithic piece.

2. The handle device as claimed in claim 1, with the inner handle further including a ridge formed on the first end of the outer periphery, with the first end section of the first helical groove being spaced from the first end section of the second helical groove along the longitudinal axis by the ridge.

3. The handle device as claimed in claim 1, with the inner and outer handles having a melting point difference smaller than 30° C.

4. The handle device as claimed in claim 1, with the inner and outer handles being made of a same material.

5. The handle device as claimed in claim 1, with the inner handle being made of an elastomeric material.
